(19) United States
(12) Patent Application Publication
(10) Pub. No.: US 2011/0238446 A1
(43) Pub. Date: Sep. 29, 2011

(54) MEDICAL RECORD ENTRY SYSTEMS AND METHODS

(76) Inventor: Mundeep CHAUDHRY, Decatur, GA (US)

(21) Appl. No.: 13/072,075

(22) Filed: Mar. 25, 2011

Related U.S. Application Data
(60) Provisional application No. 61/341,112, filed on Mar. 27, 2010.

(51) Int. Cl. G06Q 50/00; G06Q 10/00

(52) U.S. Cl. 705/3

(57) ABSTRACT

Recording systems and methods efficiently record observations made during a clinical encounter. An exemplary recording system can comprise a graphical user interface having an imaging region, a details region, and an observation region. In the imaging region, the user can choose a body area as an active body area. When an active body area is chosen, the details region can dynamically update to display a set of details that are relevant to the active body area. In the details region, the user can choose a detail as an active detail. The observation region can then dynamically update to include an observation that includes the active body area being modified by the active detail. Accordingly, the observation region can include various observations made during the clinical encounter. Other embodiments of the recording systems and methods are also disclosed herein.

### CROSS-REFERENCE TO RELATED APPLICATIONS

This application claims a benefit under 35 U.S.C. §119(e) of U.S. Provisional Application Ser. No. 61/341,112, filed 27 Mar. 2010, the entire contents and substance of which are hereby incorporated by reference as if fully set out below.

### TECHNICAL FIELD

Various embodiments of the present invention relate to the entry of medical records and, more particularly, to medical record entry systems and methods for automatically creating entries based on selections made in a dynamic graphical user interface.

### BACKGROUND

To properly diagnose and manage health issues, health practitioners generally prepare an examination record for each clinical encounter of a patient. In the past, examination records were handwritten on examination record forms. More recently, examination records are prepared and stored electronically through an electronic medical/health record (“EMR”) system, so as to be more easily manipulable and deliverable.

Although various conventional EMR systems exist, these systems are inefficient. Conventional systems are generally made up of many textual lists from which the practitioner can select desired options. For example, an EMR system may present a practitioner with a list of body parts. The practitioner may then be required to locate the body part observed on the patient, and then either type in a description of that body part or additionally locate an appropriate descriptive term in yet another list. In a conventional EMR system, the lists are generally ordered alphabetically, based on most recently used, or based on most often used. These ordering bases do not account for the fact that each list may contain hundreds of items, and patients' conditions can vary widely. As a result, an observed body part and applicable description may be extremely difficult to find with any of these three ordering schemes.

Accordingly, although conventional EMR systems enable electronic recording of clinical encounters, such recording may be highly inefficient.

### SUMMARY

There is a need for a recording system that enables practitioners to efficiently record observations and notes made during clinical encounters. It is to such as system that various embodiments of the invention are directed.

Various embodiments of the invention are recording systems and methods for generating digital examination records based on a practitioner's use of a dynamic graphical user interface. An exemplary embodiment of a recording system can include an imaging region, a details region, and an observation region.

The imaging region can display an image representing a portion of a subject's body. In an exemplary embodiment, the body displayed can be a model of the body and need not actually depict the subject being examined. The recording system can maintain a predetermined mapping of pixels in the image of the body to specific body areas. For example, and not limitation, a first pixel that forms a portion of a tibia can be mapped to the tibia body area. When a user focuses on a particular pixel, the recording system can indicate to the user which body area has focus. If desired, the user can select the focused-on pixel, thus selecting the corresponding body area. After a body area is selected by the user in some manner, the recording system can make that body area an “active” body area, to be included in an observation for recording. The active body area can be highlighted or emphasized in the graphical user interface. For example, and not limitation, the selected body area can change color in the imaging region or a dialog in the graphical user interface can display a name of the body area.

When a body area is active, the details region can dynamically select potential details related to the active body area. A detail related to a body area can be, for example, a description or characteristic of the body area, a question related to the body area, a diagnosis related to the body area, or a prescription for addressing the body area. The recording system can store, or otherwise have access to, a plurality of potential details for the body areas selectable in the recording system. Each selectable body area can be associated with a corresponding subset of the details, and in an exemplary embodiment, each detail corresponding to a body area can be a word or phrase that can plausibly be related to that body area. In an exemplary embodiment, only those details that are relevant to describing potential conditions of a particular body area are associated with that body area. When a body area is active, the details region can dynamically update to present the subset of details corresponding to the active body area. Accordingly, the system user can be presented with only those details that are potentially relevant. Each of the presented details can be selectable, such as with a mouse click or other interaction. When a detail is selected by the user, the selected detail can become “active,” like the selected body area.

The observation region can dynamically provide observations about the examination subject, where the observations can be constructed based on the active body areas and active details. When the user activates a body area and a corresponding detail, the observation region can automatically provide an observation combining the detail with the body area. Each time the user activates a body area and detail for an observation, the observation region can add a resulting observation to the observations already provided in observation region.

In an exemplary embodiment of the recording system, the examination record can be saved when the clinical counter is complete. Later, at the request of the user, the recording system can search the individual observations based on received search criteria. This can avoid the user having to search record-by-record for a relevant information in past examination records.

Accordingly, through a dynamic graphical user interface made up of the imaging region, details region, and observation region, a user of the recording system can efficiently create an examination record.

These and other objects, features, and advantages of the recording systems and methods will become more apparent upon reading the following specification in conjunction with the accompanying drawing figures.

### BRIEF DESCRIPTION OF THE FIGURES

FIG. 1 illustrates a diagram of a recording system, according to an exemplary embodiment of the present invention.

FIG. 2 illustrates a diagram of a computing device embodying the recording system, according to an exemplary embodiment of the present invention.

FIGS. 3-4 illustrate a graphical user interface of the recording system, according to an exemplary embodiment of the present invention.

FIGS. 5A-5C illustrates an exemplary pixel-mapping in the recording system, according to an exemplary embodiment of the present invention.

FIG. 6 illustrates a flow diagram of a recording method, according to an exemplary embodiment of the present invention.

### DETAILED DESCRIPTION

To facilitate an understanding of the principles and features of the invention, various illustrative embodiments are explained below. In particular, the invention is described in the context of being a recording system for recording observations related to a clinical encounter. Embodiments of the invention, however, are not limited to this context. Rather, embodiments of the invention can record observations in a variety of circumstances, including various other types of examinations and inspections. For example, and not limitation, some embodiments of the recording system might be used to record observations made during inspection of mechanical equipment or other items.

The components described hereinafter as making up various elements of the invention are intended to be illustrative and not restrictive. Many suitable components that can perform the same or similar functions as components described herein are intended to be embraced within the scope of the invention. Such other components not described herein can include, but are not limited to, similar or analogous components developed after development of the invention.

Various embodiments of the present invention are recording systems to record observations of a user, particularly during a clinical encounter. Below, this disclosure includes a general description of various embodiments of the recording systems and methods, followed by a description of use of an illustrative embodiment of the recording system.

### I. Description of Various Embodiments of the Recording Systems and Methods

Referring now to the figures, in which like reference numerals represent like parts throughout the views, various embodiment of the recording systems and methods will be described in detail.

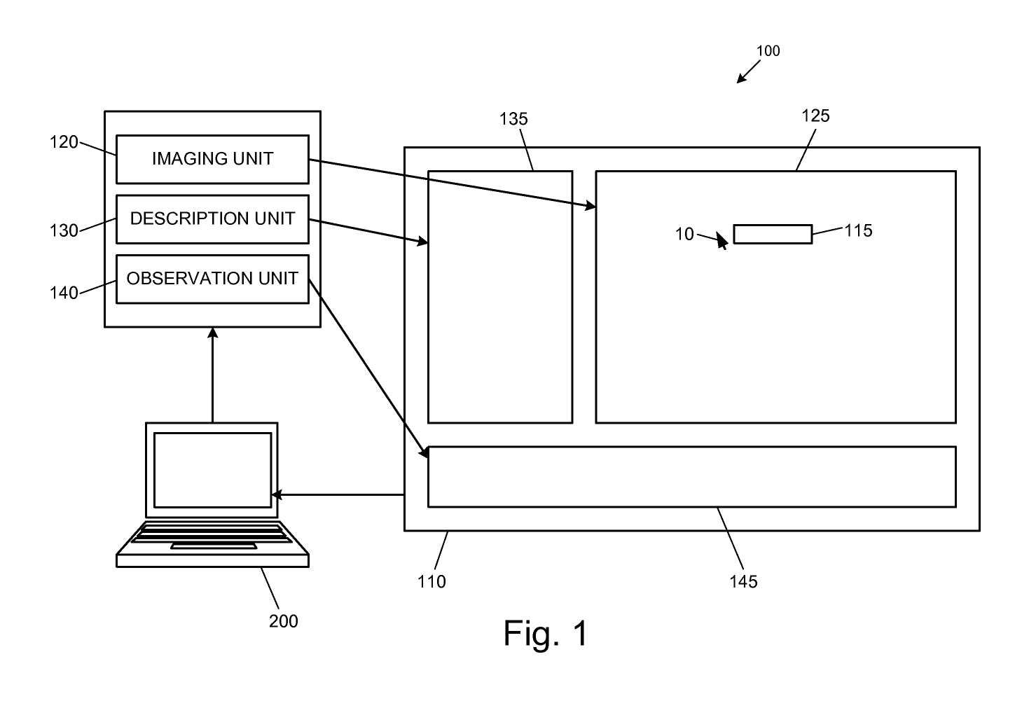

FIG. 1 illustrates a recording system, according to an exemplary embodiment of the present invention. As shown in FIG. 1, an exemplary embodiment of the recording system 100 can comprise an indicator 115, an imaging region 125, a details region 135, and an observation region 145, which can each be visible on a graphical user interface 110 of the recording system. The graphical user interface 110 can be displayed on a screen or monitor of a computing device 200. The recording system 100 can also comprise an imaging unit 120, a details unit 130, and an observation unit 140, which can drive the imaging, details, and observation regions 125,135, and 145, but may be hidden from the user.

Aspects of the graphical user interface 110, such as the indicator 115, the imaging region 125, the details region 135, and the observation region 145, need not be restricted to certain predetermined areas of the graphical user interface 110 of the recording system 100. These aspects of the graphical user interface 110 can instead be moveable or repositionable as desired by an administrator of the recording system 100 or by the user. Particularly, the indicator 115 can be dynamically positioned based on a position of a user interaction, such as the position of a mouse cursor 10. For example, and not limitation, if a mouse cursor 10 of the user is positioned over a certain pixel or area of an image displayed in the imaging region 125, the indicator 115 can appear on or near the cursor 10 to provide relevant information to the user about the interaction with the graphical user interface 110.

The user can interact with the graphical user interface 110 in various manners. User interactions with the graphical user interface 110 can include, for example, “focusing” and “selecting.” To “focus” on a pixel or other portion of the graphical user interface 110, the user can place a mouse cursor 10 over that portion, without clicking a mouse button. To “select” a pixel or other portion of the graphical user interface 110, the user can click a mouse button while focused on that portion or, with a touchscreen device, the user can simply touch the screen at the desired portion.

Generally, the imaging region 125 can display one or more images representing the examination subject; the details region 135 can display one or more possible details of an active body area displayed in the imaging region 125; and the observation region 145 can list observations recorded during the present clinical encounter. An observation can be a combination of one or more body areas and one or more details, preferably arranged into a natural language phrase or sentence. For example, and observation made up of the body area “knee” and the detail “swollen” might be as follows: “Knee is swollen.” Accordingly, when the user selects a body area and a detail, an observation can be generated that describes the selected body area by applying the selected detail.

The recording system 100 can be embodied in a computer-readable medium and executed by a computer processor on a computing device 200 to provide aspects of the invention. As shown in FIG. 1, the recording system 100 can be integrated, in whole or in part, in a computing device 200. In an exemplary embodiment, the imaging unit 120, the details unit 130, and the observation unit 140 can be integrated, in whole or in part, with the computing device 200, such as in the form of computer hardware, computer software, or a combination thereof. Generally, the imaging unit 120 can provide functionalities and processes for to the imaging region 125; the details unit 130 can provide functionalities and processes for the details region 135; and the observation unit 140 can provide functionalities and processes of the observation region 145. Although the units 120, 130, and 140 are described herein as being distinct from one another, this description is provided for illustrative purposes only, to explain the various functionalities of the recording system 100 as a whole. It will thus be understood that hardware or software incorporated into these units need not be separated into distinct components for the units described, but can overlap as needed or desired.

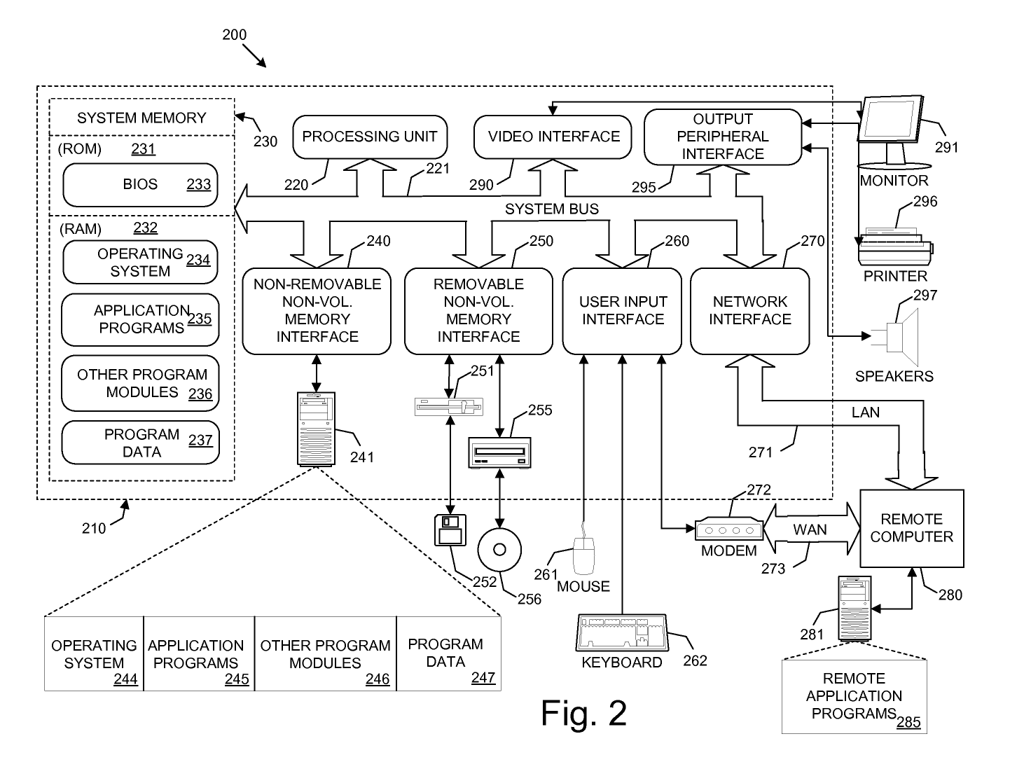

FIG. 2 illustrates an example of a suitable computing device 200 for providing the recording system 100. Although specific components of a computing device 200 are illustrated in FIG. 2, the depiction of these components in lieu of others does not limit the scope of the invention. Rather, various types of computing devices 200 can be used to implement embodiments of the recording system 100. Exemplary embodiments of the recording system 100 can be operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Exemplary embodiments of the recording system 100 can be described in a general context of computer-executable instructions, such as one or more applications or program modules, stored on a computer-readable medium and executed by a computer processing unit. Generally, program modules can include routines, programs, objects, components, or data structures that perform particular tasks or implement particular abstract data types. Embodiments of the recording system 100 can also be practiced in distributed computing environments, where tasks are performed by remote processing devices that are linked through a communications network.

With reference to FIG. 2, components of the computing device 200 can comprise, without limitation, a processing unit 220 and a system memory 230. A system bus 221 can couple various system components including the system memory 230 to the processing unit 220. The system bus 221 can be any of several types of bus structures including a memory bus or memory controller, a peripheral bus, and a local bus using any of a variety of bus architectures. By way of example, and not limitation, such architectures can include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 200 can include a variety of computer readable media. Computer-readable media can be any available media that can be accessed by the computing device 200, including both volatile and nonvolatile, removable and non-removable media. For example, and not limitation, computer-readable media can comprise computer storage media and communication media. Computer storage media includes both volatile and nonvolatile, removable and non-removable media implemented in any method or technology for storage of information such as computer readable instructions, data structures, program modules or other data. Computer storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store data accessible by the computing device 200.

Communication media can typically contain computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, and not limitation, communication media includes wired media such as a wired network or direct-wired connection, and wireless media such as acoustic, RF, infrared and other wireless media. Combinations of any of the above can also be included within the scope of computer readable media.

The system memory 230 can comprise computer storage media in the form of volatile and/or nonvolatile memory such as read only memory (ROM) 231 and random access memory (RAM) 232. A basic input/output system 233 (BIOS), containing the basic routines that help to transfer information between elements within the computing device 200, such as during start-up, can typically be stored in the ROM 231. The RAM 232 typically contains data and/or program modules that are immediately accessible to and/or presently in operation by the processing unit 220. For example, and not limitation, FIG. 2 illustrates operating system 234, application programs 235, other program modules 236, and program data 237.

The computing device 200 can also include other removable/non-removable, volatile/nonvolatile computer storage media. By way of example only, FIG. 2 illustrates a hard disk drive 241 that can read from or write to non-removable, nonvolatile magnetic media, a magnetic disk drive 251 for reading or writing to a nonvolatile magnetic disk 252, and an optical disk drive 255 for reading or writing to a nonvolatile optical disk 256, such as a CD ROM or other optical media. Other removable/non-removable, volatile/nonvolatile computer storage media that can be used in the exemplary operating environment can include magnetic tape cassettes, flash memory cards, digital versatile disks, digital video tape, solid state RAM, solid state ROM, and the like. The hard disk drive 241 can be connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2 can provide storage of computer readable instructions, data structures, program modules and other data for the computing device 200. For example, hard disk drive 241 is illustrated as storing an operating system 244, application programs 245, other program modules 246, and program data 247. These components can either be the same as or different from operating system 234, application programs 235, other program modules 236, and program data 237.

A web browser application program 235, or web client, can be stored on the hard disk drive 241 or other storage media. The web client can comprise an application program 235 for requesting and rendering web pages, such as those created in Hypertext Markup Language (“HTML”) or other markup languages. The web client can be capable of executing client side objects, as well as scripts through the use of a scripting host. The scripting host executes program code expressed as scripts within the browser environment. Additionally, the web client can execute web application programs 235, which can be embodied in web pages.

A user of the computing device 200 can enter commands and information into the computing device 200 through input devices such as a keyboard 262 and pointing device 261, commonly referred to as a mouse, trackball, or touch pad. Other input devices (not shown) can include a microphone, joystick, game pad, satellite dish, scanner, electronic white board, or the like. These and other input devices are often connected to the processing unit 220 through a user input interface 260 coupled to the system bus 221, but can be connected by other interface and bus structures, such as a parallel port, game port, or a universal serial bus (USB). A monitor 291 or other type of display device can also be connected to the system bus 221 via an interface, such as a video interface 290. In addition to the monitor, the computing device 200 can also include other peripheral output devices such as speakers 297 and a printer 296. These can be connected through an output peripheral interface 295.

The computing device 200 can operate in a networked environment using logical connections to one or more remote computers, such as a remote computer 280. The remote computer 280 can be a personal computer, a server, a router, a network PC, a peer device, or other common network node, and can include many or all of the elements described above relative to the computing device 200, including a memory storage device 281. The logical connections depicted in FIG. 2 include a local area network (LAN) 271 and a wide area network (WAN) 273, but can also include other networks.

When used in a LAN networking environment, the computing device 200 can be connected to the LAN 271 through a network interface or adapter 270. When used in a WAN networking environment, the computing device 200 can include a modem 272 or other means for establishing communications over the WAN 273, such as the internet. The modem 272, which can be internal or external, can be connected to the system bus 221 via the user input interface 260 or other appropriate mechanism. In a networked environment, program modules depicted relative to the computing device 200, such as the various units 120, 130, and 140 of the recording system 100, can be stored in the remote memory storage device. For example, and not limitation, FIG. 2 illustrates remote application programs 285 as residing on memory device 281. It will be appreciated that the network connections shown are exemplary and other means of establishing a communications link between the computers can be used.

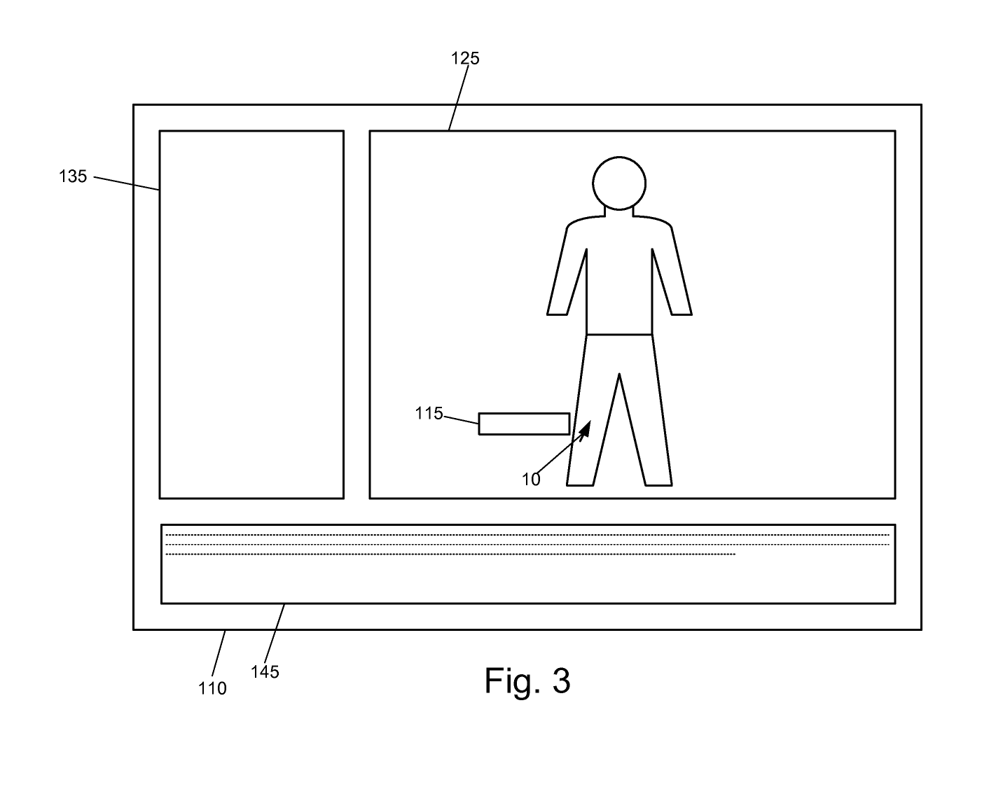

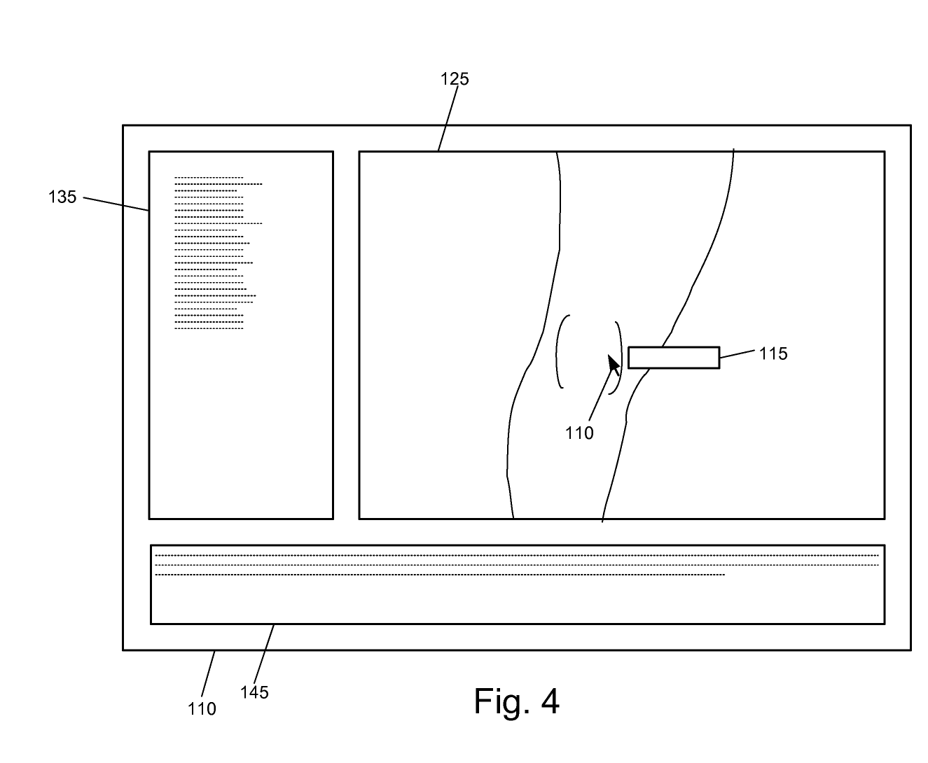

FIGS. 3-4 illustrate an exemplary dynamic graphical user interface 110 of the recording system 100, according to some embodiments of the present invention. As shown in FIG. 3, the graphical user interface 110 can comprise an imaging region 125, a details region 135, an observation region 145, and an indicator 115. In the imaging region 125, the user can choose a body area as a current “active” body area. In the details region 135, the user can choose a detail as a current “active” detail. As a result, the recording system 100 can dynamically update the observation region 145 to include an observation of the active body area being modified by the active detail. This will be described in more detail below.

The imaging region 125 can display one or more images representing the examined subject, for example, an image representing all or a portion of a patient's body. In an exemplary embodiment, the images displayed need not be the subject itself, but can instead be a representation of the subject. For example, instead of an image of the patient, the imaging region 125 can display an image of a model human body.

On a touchscreen device, interactions performed with the graphical user interface 110 can differ in some respects from interactions that might be performed with a traditional mouse. General areas, i.e., at a relatively coarse granularity, can be selected with a touch gesture in the graphical user interface 110. That touch gesture can be, for example, a swipe (i.e., moving a finger across the touchscreen over the desired area while retaining contact) or an outlining. For example, the front of the knee can be chosen with a swipe gesture over the front of the knee. For another example, the inside surface of the knee can be chosen with a swipe gesture over the inside of the knee. There can be a button or other graphical object proximate the current image, which can be used to pick the entire area that is depicted in the image, such as the “entire knee.” Body areas can be selected at a finer granularity by simply tapping or touching the touchscreen at a desired anatomical position.

Like a mouse cursor, the use of which is described above, the touchscreen device can take advantage of the pixel-mappings to make selections at various granularities. As a finger is rolled over the image, different aspects of the knee can be highlighted according to the pixel-mappings of the pixels contacted by the finger. A body area mapped to be a touched pixel can be highlighted. Accordingly, as the finger moves outward, more general areas of the body can be highlighted. A selection object can be provided in the graphical user interface 110, whereby touching the selection object can prompt the graphical user interface 110 to display a list of anatomical parts, or body areas, at or near or the highlighted area, thus enabling more precise selection than may be possible with a finger on an image. The list can include specific areas (i.e., fine granularity), such as the “patella,” and general areas (i.e., coarse granularity), such as the “entire knee.” From this list, the user can select a body area for recording an observation.

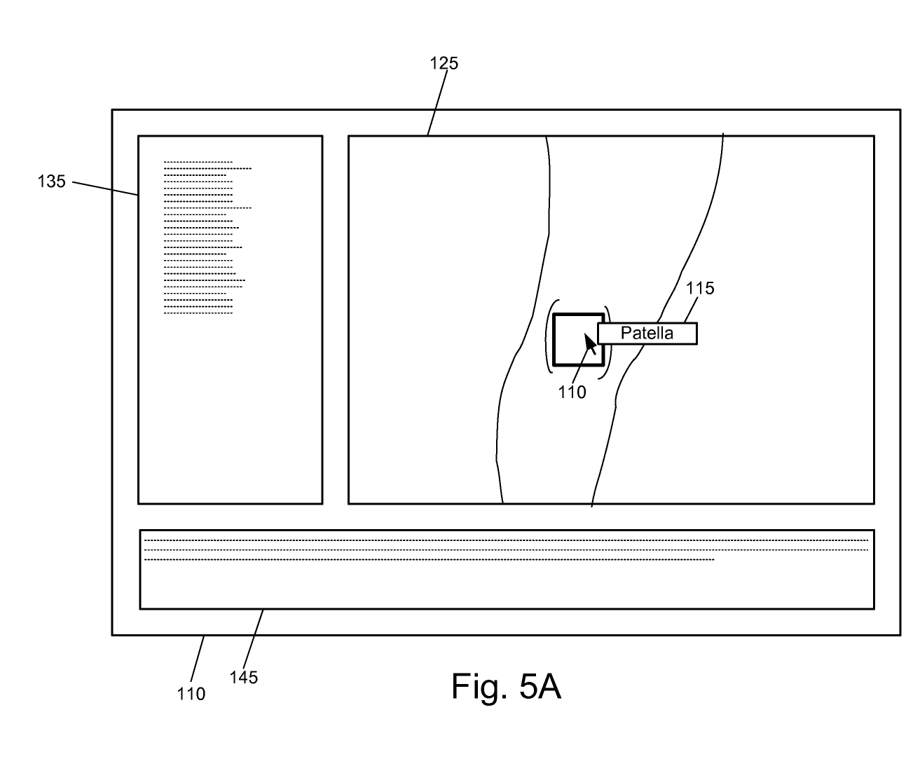

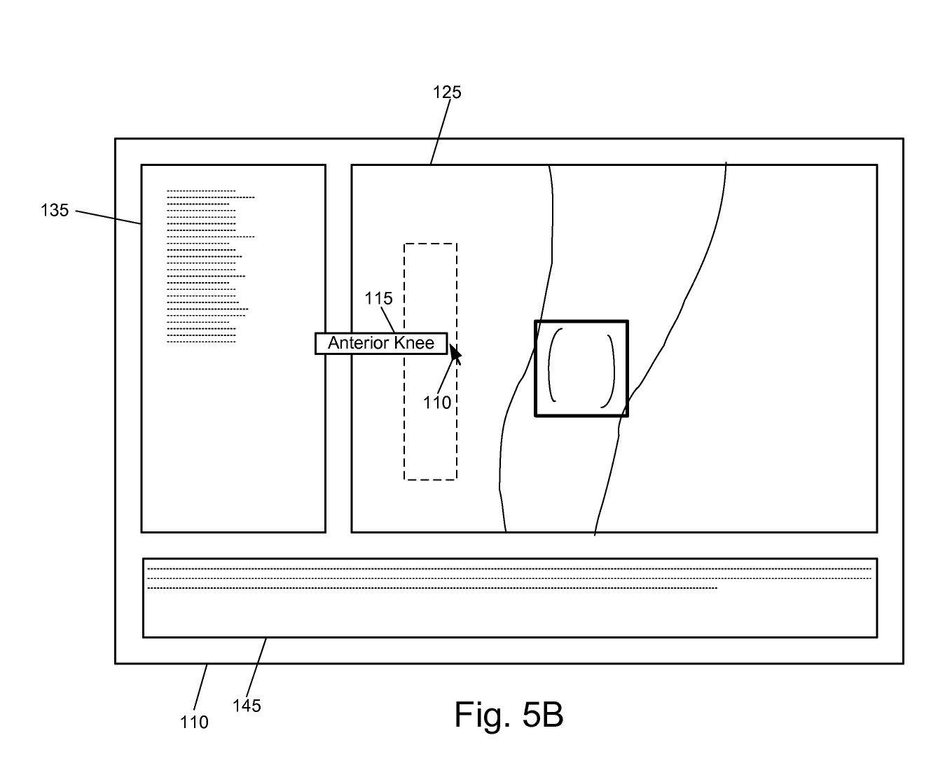

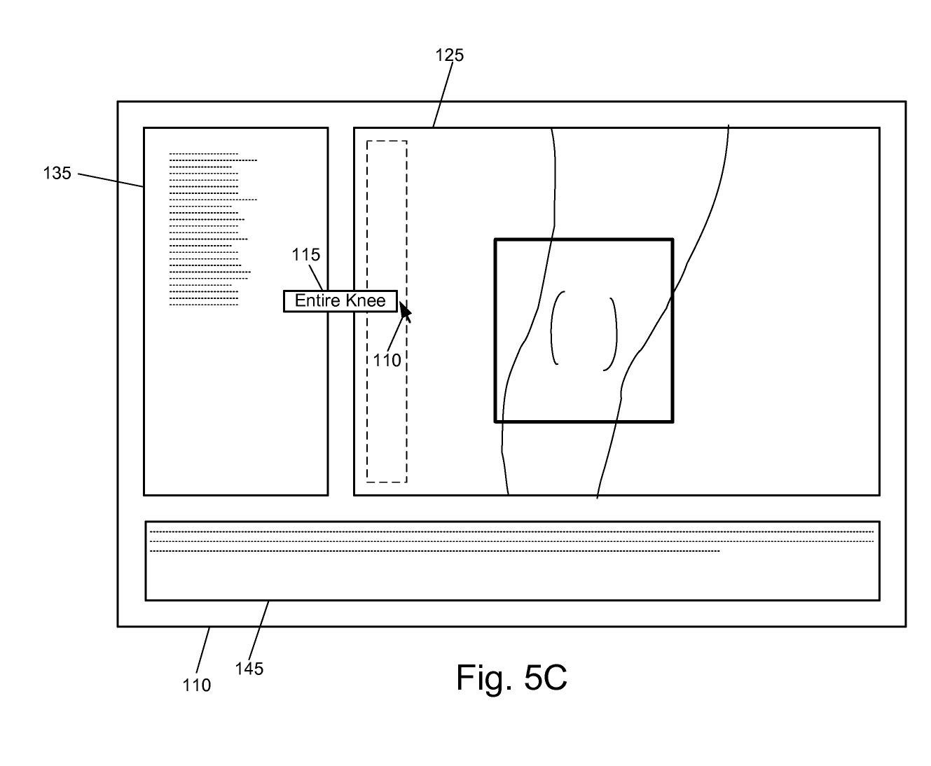

FIGS. 5A-5C illustrate exemplary pixel-mappings in the recording system, according to an exemplary embodiment of the present invention. Within an image displayed in the imaging region 125, each pixel can be mapped to a specific body area. When, in a user interaction, the user focuses-on or selects a particular pixel, the body area to which that pixel maps can be highlighted in some instances. In an exemplary embodiment, the mappings can enable various levels of granularity in selection.

FIGS. 5A-5C illustrate an exemplary progression from a relatively fine granularity of selection to a relatively coarse granularity of selection. More specifically, FIG. 5A illustrates pixel-mapping for pixels mapped to the “patella”; FIG. 5B illustrates pixel-mapping for pixels mapped to the “anterior knee”; and FIG. 5C illustrates pixel-mapping for pixels mapped to the “entire knee.” As shown in these figures, the imaging region 135 can not only highlight the mapped-to body area, but can also highlight the entire area of the set of pixels that map to that body area. This highlighting can be effected by, for example, outlining the relevant regions as shown. In an exemplary embodiment, this highlighting is temporary and can disappear automatically when the cursor is moved away from the relevant pixels.

For example, a pixel depicting the body itself can enable selection at a relatively fine granularity, as shown in FIG. 5A, while pixels toward the outside of a displayed image, as shown in FIGS. 5B-5C, which may depict background instead of the body itself, can enable selection at a coarser granularity. For example, when a user's cursor is directly over the body, as shown in FIG. 5A, the user can select body areas at a fine granularity. The pixels depicting the body itself can be mapped to the body areas depicted by those pixels at a precise level. For example, with the cursor positioned over the knee, the user can select the “patella” or the “tibial tuberosity” by moving the cursor to those specific parts of the knee. In an exemplary embodiment, the granularity becomes less precise as the cursor moves to portions of the image outside of those pixels that depict the body itself or to pixels closer to a perimeter of the image. As the cursor moves farther to the outer portions of the image, the granularity can decrease. For example, by moving outward, the user can select the “anterior knee,” as in FIG. 5B, or the “entire knee,” as in FIG. 5C. Although pixels outside the body itself, possibly depicting a background portion of the image, do not themselves depict a part of the body, they can map to larger body areas. For example, FIG. 5C depicts a set of pixels mapping to the “entire knee,” despite not depicting the knee themselves. As shown in FIGS. 5A-5C, the indicator 115 can display the body area currently mapped to by the position of the cursor, so that the user can accurately select a desired body area.

In an exemplary embodiment, a subset of pixels that maps to a first body area is mutually exclusive with a subset of pixels that maps to a second body area, even if the first and second body areas overlap. Accordingly, a particular pixel can map only to a single body area, regardless of the granularity of selection provided by that mapping. For example, as shown in FIG. 5A-5C, even though the various pixels focused-on by the cursor 110 in the figures map to overlapping body areas, the three sets of pixels that map to these three body areas are mutually exclusive.

As discussed in more detail below, observations can be dynamically constructed and displayed based on active body areas in the imaging region 125. In some embodiments, the user can activate a body area by selecting the body areas, which can be achieved, for example, by clicking with a mouse, or by touching a highlighted body area on a touchscreen device.

The recording system 100 can utilize one or more magnification levels for images in the imaging region 125. For example, and not limitation, a first magnification level can allow an entire body to be viewable in the imaging region 125, as shown in FIG. 3, while a second or high magnification level can allow a more detailed view of a portion of the body, as shown in FIG. 4. From the first magnification level, the user can select a specific portion of the body, such as the knee or the stomach, to view in greater detail. The second magnification level can display a chosen portion of the body at a higher magnification level than the first magnification level. For example, at the second magnification level of the knee area, the user can view the knee and surrounding leg but may not be able to see the stomach. At the second magnification level, the user can view and select various specific parts of the knee or other chosen body area, such as the tibial tuberosity and the patella. Other magnification levels can also be provided to view portions of the body in even greater details.

Various mechanisms can be used to provide the various magnification levels. For example, and not limitation, a single high-quality image of the entire body can be used for all magnification levels and all portions of the body, where the second magnification level and higher magnification levels can be achieved by simply enlarging and cropping the single image. Alternatively, in addition to an image of the entire body used at the first magnification level, the recording system 100 can also use various images of different portions of the body for other magnifications levels.

In some embodiments, user interaction with the imaging region 125 can be interpreted differently depending on the current magnification level of the imaging region 125, and the recording system 100 can respond differently to interactions based on the current magnification level of the imaging region 125. For example, and not limitation, in some embodiments, focusing on a pixel in the imaging region 125 can cause the indicator 115 to display a name or description of the focused-on body area regardless of the magnification level. Selection interactions, however, can be interpreted differently based on magnification level in some embodiments of the invention. For example, at the first magnification level, selecting a first portion of the imaging region 125 can cause the imaging region 125 to switch to the second magnification level, displaying the selected area at a greater magnification. Such selection at the first magnification level can also cause the selected body area (i.e., the body area to which the pixel is mapped) to become active, thus zooming in for a more detailed view and activating the selected body area. Selecting a pixel at the second or highest magnification level, however, can be interpreted by the recording system 100 as choosing the body area as active. The magnification need not be further increased if the selection is made at the highest magnification level already. Alternatively, or additionally, selection at the first magnification level can indicate a choice of a more general body area than at a higher magnification level. For example, when the user selects a pixel on the knee at the first magnification level, the knee can become an active body area. In contrast, because a more detailed and enlarged view can be provided at the second or higher magnification levels, a selection at the knee can be mapped to activation of the tibia, patella, or other part of the knee, depending on which pixel of the knee is selected. It will be understood that various mechanisms can be provided to effectively utilize and interpret focus and selection at the various magnification levels, and thus, not all options for use of the magnification levels are presented herein.

In some embodiments, the recording system 100 can provide some mechanism enabling the user to deactivate the active body area, switch to a new active body in lieu of the current active body area, or maintain multiple active body areas. For example, and not limitation, selecting an active body area can deactivate that body area. Selecting a different body area can deactivate the current body area and activate the different body area. Lastly, selecting multiple body areas while performing a predetermined other action, such as holding down the CTRL key on the keyboard, can enable activation of multiple body areas.

When a body area is active, the details region 135 can dynamically display details, or descriptive terms, associated with the active body area. The recording system 100 can store, or otherwise have access to, a plurality of details. For example, and not limitation, the details can be stored in a database or can be accessible through a third party.

Each selectable body area can be associated with a corresponding subset of the total set of available details. A detail can be, for example, a description or characteristic of a body area, a questions related to the body area, a diagnosis related to a body area, or a prescription or medication for treating or otherwise addressing a body area. In an exemplary embodiment, only those details that are relevant to a particular body area are associated with that body area. The associations can be provided so that each pairing of detail and associated body area results in a plausible observation. For example, while a “hair” body area may be associated with a “thinning” detail, “hair” would not likely be associated with a “swollen” detail, as it is not plausible for hair to be described as swollen. In some exemplary embodiments, the user can add and remove details from the recording system 100, and in some embodiments, the user can add or remove associations between details and body areas.

The associations need not be mutually exclusive in any way. Each detail can be associated with multiple body areas, and each body area can be associated with multiple details. Accordingly, each body area can be associated with a subset of the total set of descriptors.

When a body area is active, the details region 135 can automatically update to present the subset of details corresponding to the active body area. The displayed details can be sorted in a manner that is convenient to the user, such alphabetically, by most-recently used, or by most-frequently used. Accordingly, the system user can be presented with only those details that are potentially relevant. When a body area is selected in the imaging region 125, the details region 135 can dynamically display the subset of details associated with the selected body area. As a result of this display being dynamic, if the user switches his or her active selection from a first body area to a second body area, the displayed details can change automatically to reflect the subset associated with the second body area.

One or more of the details can be further qualified by second-level details, or modifiers. Each modifier can be associated with a detail and can represent an option for further qualifying the associated detail. For example, and not limitation, a first detail can be “painful,” and associated modifier can be the set of numbers 1-10, each describing a different level of painfulness. For another example, a detail “swollen” can be associated with the following set of modifiers: “none,” “mild,” “moderate,” “severe,” “increased,” “no change,” “decreased.” When a detail that has associated modifiers is activated, the details region 135 can automatically display the modifiers to allow the user to activate one or more of those as well. A resulting observation can then include the active detail as well as any active modifiers for that detail.

In some embodiments, even when no particular body area is active, the details region 125 can display one or more details that can be selected. In such instances, the displayed details can be related to general aspects of the body, or they can be related to general aspects of whichever portion of the body is displayed in the imaging region. For example, and not limitation, if the imaging region 125 currently displays an image of the knee, then the details region can display a set of details related to general knee function. This may include, for further example, details related to the subject's ability to squat.

Each of the presented details, including modifiers if applicable, can be activatable, such as with a mouse click or other interaction. When a detail is selected by the user, the selected detail can become “active,” like the selected body area. In some embodiments of the recording system 100, a mechanism can be provided to enable the user to deactivate the active detail, switch to a new active detail in lieu of the current active detail, or maintain multiple active details. For example, and not limitation, selecting an active detail can deactivate that detail. Selecting a different detail can deactivate the current detail and activate the different detail. Lastly, selecting multiple details while performing a predetermined other action, such as holding down the CTRL key on the keyboard, can enable activation of multiple details.

If multiple body areas are active at a given time, the recording system 100 can cause the details region 125 to present the details that are associated with all of the active body areas. For example, suppose that Body Area A and Body Area B are both active. If Detail A is associated with Body Area A but not Body Area B, then in some embodiments, Detail A is not displayed as an option in the details region 135. If Detail B is associated with both Body Area A and Body Area B, then Detail B can be displayed in the details region 125. The details region 135 can thus display a subset of details that represents the overlapping of the detail subsets associated with all of the active body areas. Accordingly, when multiple body areas are active, the details presented can be limited to those that are potentially relevant to all the active body areas. This can enable a compound observation to be made in an efficient manner, wherein the compound observation describes multiple body areas with the same set of details. For example, a compound observation could be: “Tibia and patella are tender.”

The observation region 145 can dynamically provide one or more observations about the subject of the clinical encounter, where the observations are constructed based on the active body areas and the active details. In an exemplary embodiment, the observations can be natural language sentences, which can be more user-friendly then the awkward machine-generated phrases created in conventional EMR systems. When the user chooses and activates one or more body areas and one or more corresponding details, the observation region 145 can automatically display an observation combining the details with the body areas. Each time the user activates a body area and detail for an observation, the observation region 145 can dynamically and automatically add a resulting observation to the observations already provided in observation region 145, so the observation region 145 remains updated to the user's choices.

An observation can be a sentence or phrase that includes one or more body areas and one or more relevant details. The observation region 145 can be updated with a new observation by combining the active one or more body areas with the active one or more details. Because the currently available details can be limited to only those relevant to the active body areas, the resulting observation can thus be a plausible phrase describing the subject's condition.

In some embodiments, the recording system 100 can require some form of confirmation that the user is happy with his or selections, for example, selection of a confirmation button. This need not be required, however, and the recording system 100 can alternatively assume that selection of an active body area and an active detail confirms an observation. In either case, the recording system 100 can provide some option for modifying or deleting observations with which the user is not pleased. For example, activating additional body areas, additional details, or both can modify a newly added observation to include the additional body areas and details. Selecting an observation and then performing a predetermined action, such as also selecting a delete button on the graphical user interface 110 or on the keyboard, can remove that observation from the observation region 145.

In some embodiments, observations that were previously recorded in the observation region 145 can be modified, such as by activating body areas, details, or both that form a part of those observations. More specifically, for example, if a body area is activated along with all details used in a previous observation, then that body area can be dynamically added to that previous observation. Analogously, for another example, if a detail is activated along with all body areas used in a previous observation, then that previous observation can be dynamically modified to include the currently active detail. For example, and not limitation, if the observation region 145 includes a previous detail that states, “Tibial tuberosity is swollen,” then later activating the “patella” body area and the “swollen” detail can modify this previous observation to “Tibial tuberosity and patella are swollen.”

Some exemplary embodiments of the recording system 100 can include a mechanism for including default observations in the observation region 145. A default observation can describe a body area as being normal or otherwise indicate that no negative or relevant issues were noted for a particular body area during a clinical encounter. A default observation can be made for a particular body area, such as by activating that body area and then indicating normality, such as by selecting a predetermined button supplied in the graphical user interface 110 for this purpose. Alternatively, a default observation can be made for all or a subset of body areas that are not yet included in observations. For example, when a predetermined action is performed, such as the selection of a predetermined button on the graphical user interface 110, the observation region 145 can be filled in with a list of observations indicating that various specific body areas are normal. The specific body areas can be selected to be those that are not yet included in any observations. Accordingly, after any abnormalities in the clinical encounter are noted through activating various body areas and associated details, observations for normalities can then be created automatically.

Some embodiments of the recording system 100 can have multiple modes of operation, wherein a different category of data can be recorded in each mode. For example, and not limitation, the following are categories of data that may be recorded by the recording system 100: demographics, review of systems, past medical history, past surgical history, family history, social history (e.g., smoking, alcohol-usage, drug-usage, occupation), current medications, allergies, physical examination, imaging studies, diagnoses, treatment plan, lab orders, and prescriptions (i.e., prescriptions written at the time of the clinical record). These categories may overlap in some respects and need not be mutually exclusive.

If multiple data categories are provided by the recording system 100, then one or more of the categories can correspond to an operating mode of the recording system 100, wherein a particular category of data can be recorded while the recording system 100 is in the corresponding operating mode. For the sake of simplicity and intuitiveness, an exemplary embodiment of the recording system can have a one-to-one correspondence between data categories and operating modes, but this need not be the case.

Operation of the recording system 100 can vary between operating modes. For example, an operating mode can simply present an interface, such as the observations region 145 of the graphical user interface 110 described above, for the user to enter observations directly. One or more of the operating modes can include the imaging region 125, details region 135, observation region 145, or a combination of these. The types of details provided in the details region can vary based on the particular mode, so as to provide various categories of resulting observations across different operating modes. For example, and not limitation, the modes corresponding to the review of systems, past medical history, past surgical history, family history, current medications, physical examination, diagnoses, lab orders, and prescriptions categories can each be associated with modes whose details differ between modes. In the modes for each of these data categories, the recording system 100 can present the graphical user interface 110 having the imaging region 125, the details region 135, and the observation region 145, where the type of details can vary between the modes.

In some embodiments, the details available to the recording system 100 can be organized into categories or types, including, for example, a descriptions category, a medications category, and a diagnoses category. Each category of details can correspond to a mode of operation of the recording system. For example, the descriptions category can correspond to an examination mode; the medications category can correspond to a prescription mode; the lab orders category can correspond to a labs mode; and the diagnoses category can correspond to a diagnosis mode. The current mode of the recording system 100 can determine what types of details are presented and, thus, what types of observations appear in the observations region 145.

In the examination mode, the observations can describe one or more body areas being examined. For example, the terms “swollen” and “painful” may be included in the set of details used for this mode. A resulting observation could be, for example: “Right knee swollen and painful.” Accordingly, this mode can used to record the results of a physical examination.

In the mode for recording data in the review of systems, which can be referred to as a “review mode,” the details can be questions. The user can select various body areas. When a body area is active, the details region can display one or more questions related to the active body area. In this mode, the modifiers (i.e., second-level details) can be possible answers to the active questions. Accordingly, the user can choose a body area, and can then answer predetermined questions related to that body area by selecting the appropriate details in the details region 135. As a result, the observation region 145 can display phrases or sentences reflecting the various questions and their answers. In this mode, the user can review various anatomical systems of the subject, based on a predetermined set of questions for each system.

In the prescriptions mode, the observations can be prescriptions for the chosen body areas. The details region 135 can thus dynamically display medications associated with the active body areas. For example, “acetaminophen” may be included among the details available in the prescriptions mode. Each medication can be associated with relevant body areas. A medication that could plausibly be prescribed for an issue pertaining to a particular body area can be associated with that particular body area. As with other details, the user can add and remove medications in the recording system 100 as desired. Accordingly, when a body area is active, a subset of medications relevant to that body area can dynamically appear in the details region 135. When the user activates one or more body areas and one or more associated medications, the observation region 145 can dynamically provide a prescription that combines the active body areas with the active medications. The prescription can then be outputted electronically or to hard copy.

In the diagnosis mode, the observations can be diagnoses related to the chosen body areas. For example, “migraine” may be included among the details available in the diagnoses mode (and would likely be associated with a “head” body area). As with other details, the user can add and remove diagnoses in the recording system 100 as desired. The details region 125 can display a list of diagnoses potentially relevant to the active one or more body areas. For example, if the active body area is “right ankle,” the list of diagnoses in the details region 135 may include “sprain,” “fracture,” and “contusion.” Activating a diagnosis, such as “sprain,” can then prompt the observation region 145 to display the compete diagnosis, such as the following: “Right ankle sprain.”

Analogously: In a mode for recording data about lab orders, the details can be lab tests; in a mode for recording data about past medical history, the details can be descriptions of possible abnormalities; in a mode for recording data about past surgical history, the details can be procedures; in a mode for recording data about family history, the details can be conditions, and the modifiers can be family members; and in a mode for recording data about current medications, the details can be medications. Additional or alternative operation modes and categories of details can also be provided. In some exemplary embodiments, an operation mode can also be included for interpreting radiology images, such as X-rays, CT scan images, MRI scan images, or ultrasound images. In this mode, the imaging region 135 can display one or more radiology images, and the details can be descriptions potentially related to the parts of the radiology image.

When the user has made all desired observations for a particular clinical encounter, the user can save or output the set of observations as a clinical record. In an exemplary embodiment, the recording system 100 can provide an import functionality. Accordingly, when a follow-up clinical encounter takes place, the user can start with the observations from the previous clinical encounter, instead of recreating each and every observation.

The saved clinical record can retain the categorizations of the observations made in the clinical record. Accordingly, the stored clinical record can comprise various parts, or categories, or data corresponding to the observation made in various modes.

The recording system 100 can further comprise a search unit for searching past clinical records. The search unit can search clinical records based on various search queries, where a search query can be a particular category of data or a particular body area.

After the user has identified a particular subject having associated clinical records stored in the recording system 100, the user can then search the subject's past clinical records. The graphical user interface 110 can include one or more search objects or options, such as a button, enabling the user to search saved observations in stored clinical records. Each such search object can be associated with a different manner of searching past observations. A search object can be provided for each of the categories of data, wherein selecting a particular search object can cause the search unit to conduct a search using the associated category of data as the search query. For example, selecting a search object for physical examination can initiate a search for demographic data of the subject in previous clinical records. Each search object can be appropriately labeled to indicate to the user which search will be initiated by each object. For example, and not limitation, the search objects can be labeled as “Dem,” “ROS,” “PMH,” “PSH,” “SH,” “Med,” “Alrg,” “PE,” “Img,” “Diag,” “Plan,” “Labs,” and “Rx,” corresponding respectively to data in the categories of demographics, review of systems, past medical history, past surgical history, social history, current medications, allergies, physical examination, imaging studies results, diagnoses, treatment plan, lab orders, and prescriptions.

In some embodiments, there can be an additional search object, which may be labeled “HPI,” for initiating a search for data related to history of present illness. The search unit can conduct a search for history of present illness to view observations related to a particular issue or body area. For example, such a search can provide as search results observations related only to a selected or active body area, or only those observations that are categorized as data in the history of present illness category, such as observations recorded in a history of present illness mode.

When the user selects a search object, the user can be presented with a list of previous observations that result from running the search related to the search object, thereby filtering the data from previous clinical records of the current subject. In some embodiments, the search can be further narrowed based on an active body area, so that the search filters out entries unrelated to the active body area. The resulting list of previous observations can be ordered, such as chronologically or by level of severity, and dated for the user's convenience. In some embodiments, the list can span multiple pages or screens, in which case the user can browse between the pages or screens to identify the observations for which the user seeks. When a particular past observation is selected by the user from the list, the recording system 100 can then present the entire examination record that includes that observation, including all other observations made during that same clinical encounter. Selecting the search object again can return the user the prior screen, such as a screen related to the present clinical encounter.

Accordingly, by using the various search objects, the user can get a longitudinal view of the subject's history, without having to individually open and inspect each prior clinical record.

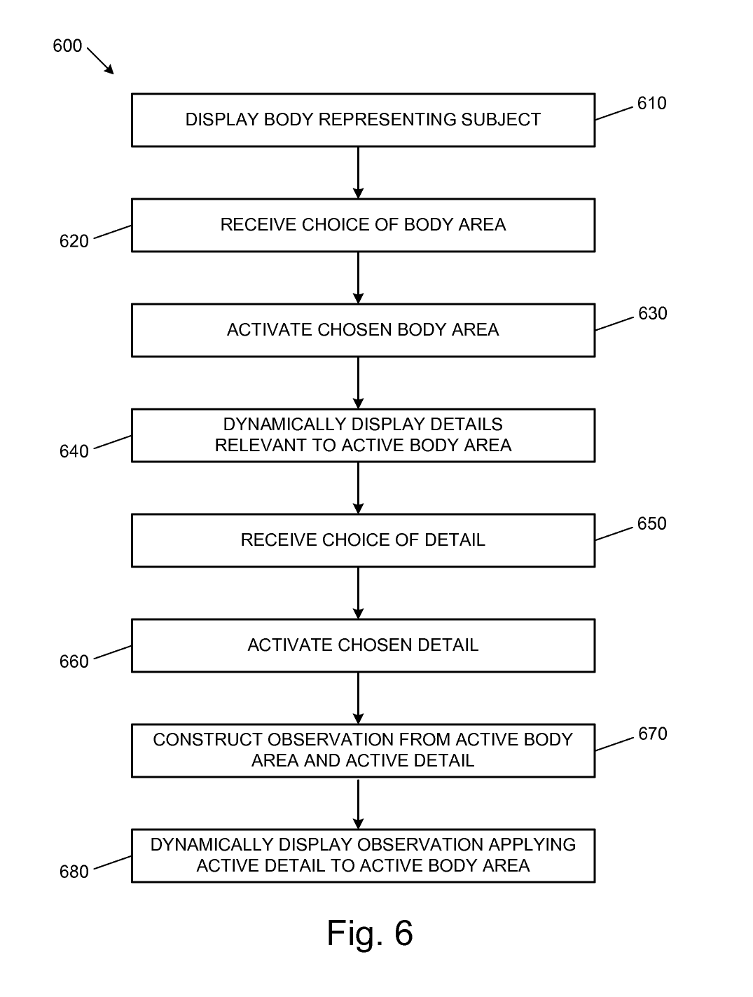

FIG. 6 illustrates a recording method 600, according to an exemplary embodiment of the present invention, which can be performed by the recording system 100. As shown, at 610, a body can be displayed, such as in the imaging region 125. At 620, a selection of one or more body areas within the body can be received. At 630, the selected body areas can be set as active body areas. At 640, a set of descriptions can be displayed, such as in the details region 135. At 650, a selection of one or more descriptions can be received. At 660, the selected descriptions can be set as active descriptions. At 670, an observation can be constructed form the active body areas and the active descriptions. At 680, the observation can be displayed, such as in the observation region 145, combining the active body areas with the active descriptions.

Below, a specific example of a use of the recording system 100 is presented. It will be understood that this example is provided for illustrative purposes only and does not limit the scope of the invention.

### II. Exemplary Use of an Illustrative Embodiment of Recording System

An exemplary graphical user interface 110 of the recording system 100 can initially present a clinician with two silhouettes of a human body model in the imaging region 125 at a first magnification level. One silhouette can be the front perspective of the body and the other a back perspective. As the clinician scrolls over the various parts of the body with a mouse cursor 10, a rectangle can appear outlining exactly what body part is focused-on, and the indicator 115 can display the name of the anatomical area. When the mouse cursor 10 focuses on the right knee, the indicator 115 can display the phrase “right knee.” When the clinician then selects the current pixel, which is associated with the right knee, a detailed right knee can then be displayed in the imaging region 125 at a second magnification level. In some embodiments, a first image can be displayed of the front of the knee, and a second image can show the back of the knee.

At the second magnification level, the user can more easily select individual parts of the right knee. As the cursor 10 moves about the knee, the indicator 115 can indicate which part of the knee currently has focus, thus enabling the user to accurately select the desired body area of the knee. One or more pixels in the displayed images can be mapped to the “entire knee.” In this example, the user selected one of such pixels, thereby activating the “entire right knee” body area.

When “entire right knee” becomes active, the details region 135 can automatically display a list of descriptions, which can include, for example, “crepitus”, “swelling”, and “ecchymosis.” Descriptions not relevant to “entire right knee” need not be displayed in the details region 135, thus minimizing distraction by irrelevant descriptors.

If the description “swelling” is selected and activated in the details region 135, a set of modifiers can then be displayed. The modifiers can qualify the severity of the active description. In the case of “swelling,” the modifiers can include, for example, “none,” “mild,” “moderate,” “increased,” and “decreased.”

With “entire right knee” activated, along with “swelling” and “moderate” being activated, the recording system 100 can construct the following observation, for example: “Moderate swelling over the entire knee.” This observation can be dynamically and automatically displayed in the observation region 145 in response to the selections, and resulting activations, of the body area and descriptions.

In this manner, the clinician can record all the observations necessary to document a complete examination of the knee.

### III. Conclusion

As discussed above in detail, various embodiments of the present invention can provide effective and efficient mean for recording observations made during a clinical encounter and, later, to search those observations based on various categories of data.

Although recording systems and methods have been disclosed in exemplary forms, many modifications, additions, and deletions may be made without departing from the spirit and scope of the system, method, and their equivalents, as set forth in the following claims.

1. A recording system comprising:
an imaging unit for displaying an image of two or more body areas, and for receiving a choice of a first body area;
a details unit for dynamically displaying, in response to the choice of the first body area, a first set of two or more details associated with the first body area, and for receiving a choice of a first detail; and
an observation unit for translating the choice of the first body area and the choice of the first detail into a first observation, the first observation comprising an application of the first detail to the first body area, and for dynamically displaying the first observation.

2. The recording system of claim 1, further comprising:
a database comprising a plurality of previous observations, each of the previous observations being part of an associated clinical record recorded at a previous time, and each of the previous observations being categorized into a plurality of categories; and
a search unit for filtering the previous observations based on a selected category to identify one or more relevant observations belonging to the selected category from among the previous observations.

3. The recording system of claim 2, the plurality of categories for the previous observations comprising at least one of history of present illness, demographics, review of systems, past medical history, past surgical history, social history, current medications, allergies, physical examination, imaging studies results, diagnoses, treatment plan, and prescriptions.

4. The recording system of claim 2, further comprising:
displaying the relevant observations;
receiving a selection of a first relevant observation from among the relevant observations displayed; and
presenting, in response to the selection of the first observation, the clinical record associated with the first observation.

5. The recording system of claim 1, the first set of details comprising medications related to the first body area.

6. The recording system of claim 1, the first set of details comprising diagnoses related to the first body area.

7. The recording system of claim 1, the first set of details comprising procedures related to the first body area.

8. The recording system of claim 1, the first set of details comprising questions related to the first body area.

9. The recording system of claim 1, the first set of details comprising lab tests related to the first body area.

10. The recording system of claim 1, the image displayed by the imaging unit being a radiology image.

11. The recording system of claim 1, the first set of details consisting only of details deemed relevant to the first body area.

12. The recording system of claim 1, further comprising a database comprising the first set of details and associating the first set of details with the body area.

13. The recording system of claim 12, the database further comprising a second set of details absent associations with the first body area, wherein first set of details displayed in the details region in response to the choice of the first body area excludes the second set of details.

14. The recording system of claim 1, the imaging unit further configured to receive a choice of a second body area or a second detail, and the observation unit translating the choice into a second observation and configuring the observation region to display the second observation in addition to the first observation.

15. The recording system of claim 1, the observation region further configured to display a set of default observations in addition to the first observation.

16. The recording system of claim 1, the details region further configured to display dynamically a set of second-level details in response to receiving the choice of the first detail, each of the second-level details comprising a qualifier for the first detail.

17. The recording system of claim 1, the details region further configured to receive a choice of a second detail in the set of descriptors, and the observation unit being configured to modify the first observation to replace the first detail with the second descriptor in the first observation.

18. The recording system of claim 1, further comprising a graphical user interface having an imaging region comprising a plurality of pixels, a first set of the plurality of pixels being mapped to the first body area, wherein the a selection of any of the first set of the plurality of the pixels is interpreted as the choice of the first body area.

19. The recording system of claim 18, the plurality of pixels of the imaging region further comprising a second set of pixels mutually exclusive with the first set of pixels, the second set of pixels being mapped to a second body area, wherein the first body area is a sub-part of the second body area.

20. The recording system of claim 19, the second set of pixels being closer to a perimeter of the image than the first set of pixels.

21. The recording system of claim 19, the first set of pixels depicting the first body area, and the second set of pixels excluding all pixels in the imaging region that depict the first body area.

22. A computer-implemented recording method comprising:
displaying an image of two or more available body areas;
receiving a choice of a first body area of the two or more available body areas;
filtering a set of details into a first subset of details that are relevant to the first body area;
displaying the first subset of the details dynamically in response to the choice of the first body area;
receiving a choice of a first detail from among the first subset of details;
configuring a computer processor to construct a first observation by applying the first detail to the first body area; and
displaying the first observation.

23. The method of claim 22, further comprising establishing associations between the first body area and each of the details in the first subset of details, based on each of the details in the first subset of details being deemed relevant to the first body area.

24. The method of claim 23, the first subset of details comprising a set of questions, lab tests, medications, diagnoses, or procedures associated with the first body area.

25. The method of claim 22, further comprising displaying a default observation in addition to the first observation.

26. The method of claim 25, the default observation indicating that one or more body areas are unremarkable.

27. The method of claim 22, further comprising:
receiving a choice of a second detail from among the first subset of details; and
modifying the first observation to include the second detail.

28. The method of claim 22, further comprising:
receiving a choice of a second body area;
filtering the set of details into a second subset of details that are relevant to the second body area;
receiving a choice of a second detail from among the second subset of details; and
constructing a second observation by applying the second detail to the second body area.

29. A computer program product embodied in a computer-readable medium, the computer program product comprising an algorithm adapted to effectuate a recording method, the method comprising:
displaying an image of two or more available body areas;
receiving a choice of a first body area of the two or more available body areas;
including the first body area in a set of active body areas, in response to the choice of the first body area;
filtering a set of details into a first subset of details that are relevant to the first body area;
displaying the first subset of the details dynamically in response to the choice of the first body area;
receiving a choice of a first detail from among the first subset of details;
including the first detail in a set of active details, in response to the choice of the first detail; and
providing a first observation by combining the set of active body areas into a phrase with the set of active details.

30. The computer program product of claim 29, the method further comprising:
receiving a choice of a second body area;
updating the set of active body areas to include the second body area, in response to the choice of the second body area; and
modifying the first observation to reflect the updated set of active body areas.

31. The computer program product of claim 29, the method further comprising:
receiving a choice of a second detail;
updating the set of active details to include the second detail, in response to the choice of the second detail; and
modifying the first observation to reflect the updated set of active details.
